(19) United States
(12) Patent Application Publication
(10) Pub. No.: US 2013/0244042 A1
(43) Pub. Date: Sep. 19, 2013

(54) ANTI-CORROSIVE PHOPHINATE FLAME RETARDANT COMPOSITIONS

(71) Applicants: Ernst Minder, Sissach (CH); Heinz Herbst, Lorrach (DE)

(72) Inventors: Ernst Minder, Sissach (CH); Heinz Herbst, Lorrach (DE)

(73) Assignee: BASF SE, LUDWIGSHAFEN (DE)

(21) Appl. No.: 13/988,523

(22) PCT Filed: Dec. 1, 2011
(86) PCT No.: PCT/EP11/71514

§ 371 Date: May 21, 2013

Related U.S. Application Data
(60) Provisional application No. 61/418,883, filed on Dec. 2, 2010.

(30) Foreign Application Priority Data
Dec. 2, 2010 (EP) 10193430.5

(51) Int. Cl. C08K 3/22; C08K 5/098; C08K 5/5313

(52) U.S. Cl. CPC C08K 3/22; C08K 5/5313; C08K 5/098
USPC 428/413; 523/451

(57) ABSTRACT

The present invention relates to flame retardant polymer compositions which comprise phosphinic acid salts in combination with polymer chain extension agents on the basis of epoxide structures and oxides or hydroxides of selected metals. The compositions are especially useful for the manufacture of flame retardant compositions based on thermoplastic polymers, especially polyolefin homo- and copolymers, such as polybutylene terephthalate (PBT).

The present invention relates to flame retardant polymer compositions which comprise phosphinic acid salts in combination with polymer chain extension agent on the basis of epoxide structures and oxides or hydroxides of selected metals. The compositions are especially useful for the manufacture of flame retardant compositions based on thermoplastic polymers, especially polyolefin homo- and copolymers, such as polybutylene terephthalate (PBT).

Flame retardants are added to polymeric materials (synthetic or natural) to enhance the flame retardant properties of the polymers. Depending on their composition, flame retardants may act in the solid, liquid or gas phase either chemically, e.g. as a spumescent by liberation of nitrogen, and/or physically, e.g. by producing a foam coverage. Flame retardants interfere during a particular stage of the combustion process, e.g. during heating, decomposition, ignition or flame spread.

There is still a continuous need for flame retardant compositions with improved properties for use in different polymer substrates. Increased standards with regard to safety and environmental requirements result in stricter regulations. Particularly known halogen containing flame retardants no longer match all necessary requirements. Therefore, halogen free flame retardants are preferred, particularly in view of their better performance in terms of smoke density associated with fire. Improved thermal stability and less corrosive behaviour are further benefits of halogen free flame retardant compositions.

The salts of phosphinic acid (phosphinates) have proven to be effective flame-retardant additives for thermoplastic polymers. This applies to the alkali metal salts, cf. DE-A-2 252 258 and to the salts with other metals as well, cf. DE-A-2 477 727.

Calcium phosphinates and aluminium phosphinates have been described as particularly effective in polyesters and give less impairment of the material properties of the polymeric molding compositions the corresponding alkali metal salts, cf. EP-A-0 699 708.

Synergistic combination of the phosphinates, as mentioned, with nitrogen-containing compounds have also been disclosed, and in a large number of polymers these are more effective flame retardants than the phosphinates alone, see PCT/EP97/01664 and DE-A-197 34 437 and DE-A-197 37 727.

When the phosphinates are present in flame retardant polyester or polyamide compositions as individual components or combined with other flame retardants, the result is generally some degree of polymer degradation, which has an adverse effect on mechanical properties.

Literature discloses various additives intended for use in polyesters and polyamides. These additives counteract by polymer chain extension against polymer degradation by hydrolysis and thermal stress during processing. These additives are known as chain extenders and allow the preparation of high molecular weight polyamides or polyesters.

US 2005/137300 discloses chain extenders for use in flame retardant combinations based on phosphinates with the advantage of inhibiting polymer degradation caused by the phosphinates but without impairing flame retardancy.

WO 2009/109318 the reduction of corrosion of metal parts and abrasion of metal surfaces in metal equipment caused by flame retardant combinations based on phosphinates by the addition of oxide or hydroxide of selected metals, such calcium oxide, in optional combination with alkali metal or earth alkaline metal salt of an organic carboxylic acid, such as sodium stearate.

The problem to which the present invention relates is seen in the further improvement of anticorrosive and mechanical properties, such as a lower degree of Izod Impact Strength and lower amounts of melt volume rate (MVR) of the polymers present in flame retardant compositions.

It has surprisingly been found that the combined addition of polymer chain extension agent on the basis of epoxide structures, with an oxide or hydroxide of a selected metal results in the desirable improvement of anticorrosive and mechanical properties of flame retardant compositions.

The following invention relates to a composition, particularly a flame retardant composition, which comprises
a) A salt of a phosphinic acid as represented by the structural formulae

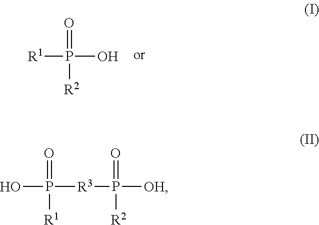

Wherein
R¹ and R² represent hydrogen or a linear or branched C₁-C₈alkyl radical, or a phenyl radical; and
R³ represents a linear or branched CᵣC₁₀alkylene, arylene, alkylarylene, or arylalkylene radical;
b) At least one polymer chain extension agent on the basis of epoxide structures; and
c) An oxide or hydroxide of a metal selected from the group consisting of alkali metals, earth alkaline metals, aluminium, titanium, zinc, antimony and bismuth.

According to a preferred embodiment, the composition additionally comprises
d) An alkali metal or earth alkaline metal salt of an organic carboxylic acid.

According to a highly preferred embodiment the composition additionally comprises
e) A polymer substrate.

The compositions defined above for use as a flame retardant is another embodiment of the invention.

The compositions according to the invention exhibit excellent flame retardant properties at low concentrations of the components a) and b). Dependent on the concentrations of components a) and b) in the polymer substrate, V-2 ratings according to UL-94 (Underwriter's Laboratories Subject 94) and other excellent ratings in related test methods are attained.

In addition, the compositions of the invention are characterized by their excellent anti-corrosive and mechanical properties, such as a low degree of Izod Impact Strength and low amounts of melt volume rate (MVR).

The composition, as defined above, comprises the following components:

### Component a)

The term phosphinic acid comprises within its scope derivatives of phosphinic acid, H₂P(═O)OH, wherein one or two hydrogen atoms, which are directly attached to the phosphorus atom, have been substituted by organic substituents, such as C₁-C₈alkyl.

The term phosphinic acid also comprises within its scope the tautomeric form HP(OH)₂, wherein the hydrogen atom which is directly attached to the phosphorus atom is substituted by organic substituents, such as C₁-C₈alkyl.

The term salt of phosphinic acid comprises within its scope preferably a metal salt, for example an alkali metal or alkaline earth metal salt, e.g. the sodium, potassium, magnesium or calcium salt or the iron(II), iron(III), zinc or boron salt.

R¹ and R² defined as C₁-C₈alkyl is straight or, where possible branched C₁-C₈alkyl and is for example methyl, ethyl, n-propyl, n-butyl, sec-butyl, tert-butyl, n-hexyl, n-octyl or 2-ethylhexyl.

R³ defined as C₁-C₁₀alkylene is straight chain or, where possible branched C₁-C₁₀alkylene, e.g. methylene, ethylene, 1,2- or 1,3-propylene or 1,2-, 1,3- or 1,4-butylene.

R³ defined as C₂-C₁₀alkylene interrupted by phenylene is, for example a bivalent group of the partial formulae

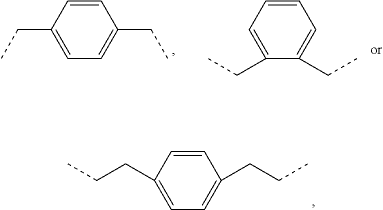

wherein the dotted lines point to the carbon atom of attachment.

R³ defined as phenylene is 1,2-, 1,3- or 1,4-phenylene.

R³ defined as (C₁-C₄alkyl)₁₋₃phenylene is, for example, 1,2-, 1,3- or 1,4-phenylene substituted by 1-3 methyl or ethyl groups.

R³ defined as phenyl-C₁-C₄alkylene is, for example, one of the above-mentioned C₁-C₈alkyl groups substituted by phenyl.

According to a preferred embodiment, the composition comprises the aluminium salt of diethylphosphinic acid.

According to an alternative embodiment, the term salt comprises non-metallic salts, e.g. the acid addition salts obtainable by reaction of phosphinic acid with ammonia, amines or amides, e.g. the (C₁-C₄alkyl)₄N⁺, (C₁-C₄alkyl)₃NH⁺, (C₂-C₄alkylOH)₄N⁺, (C₂-C₄alkylOH)₃NH⁺, (C₂-C₄alkylOH)₂N(CH₃)₂⁺, (C₂-C₄alkylOH)₂NHCH₃⁺, (C₆H₅)₄N⁺, (C₆H₅)₃NH⁺, (C₆H₅CH₃)₄N⁺, (C₆H₅CH₃)₃NH⁺, NH₄⁺, melamine or guanidine salt.

Among the acid addition salts the ammonium, (C₁-C₄alkyl)₁₋₄ammonium or (2-hydroxyethyl)₁₋₄ammonium, e.g. tetramethylammonium, tetraethylammonium, the 2-hydroxyethyltrimethylammonium, melamine or guanidine salt are particularly preferred.

According to a particularly preferred embodiment, the salt of a phosphinic acid (I) is represented by the formula

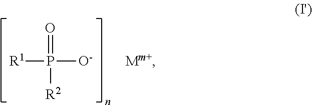

In which

one of R¹ and R² represents hydrogen or C₁-C₈alkyl; or both R¹ and R² represent C₁-C₈alkyl;
M represents (C₁-C₄alkyl)₄N, (C₁-C₄alkyl)₃NH, (C₂-C₄alkylOH)₄N, (C₂-C₄alkylOH)₃NH, (C₂-C₄alkylOH)₂N(CH₃)₂, (C₂-C₄alkylOH)₂NHCH₃, (C₆H₅)₄N, (C₆H₅)₃NH, (C₆H₅CH₃)₄N, (C₆H₅CH₃)₃NH, NH₄, melamine, guanidine, an alkali metal or earth alkali metal ion, or an aluminium, zinc, iron or boron ion;
m is a numeral from 1-3 and indicates the number of positive charges on M; and
n is a numeral from 1-3 and indicates the number of phosphinic acid anions corresponding to M^{m+}.

According to a particularly preferred embodiment, the salt of a phosphinic acid (I) of Component a) is represented by the formula

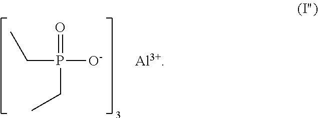

### Component b)

According to a representative embodiment of the invention, the polymer chain extension agent of Component b) consists of polyfunctional epoxide compound, wherein at least two epoxy groups of the partial formula

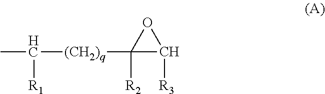

are present, which are attached directly to carbon, oxygen, nitrogen or sulphur atoms, and wherein q represents zero, R₁ and R₃ both represent hydrogen and R₂ represents hydrogen or methyl; or wherein q represents zero or 1, R₁ and R₃ together form the —CH₂—CH₂— or —CH₂—CH₂—CH₂— groups and R₂ represents hydrogen.

Examples of polyfunctional epoxide compounds are:
I) Polyglycidyl esters and poly(β-methylglycidyl) esters obtainable by reacting a compound having at least two carboxyl groups in the molecule with epichlorohydrin and/or glyceroldichlorohydrin and/or β-methylepichlorohydrin. The reaction is carried out in the presence of bases.
   Suitable compounds having at least two carboxyl groups in the molecule are aliphatic polycarboxylic acids, such as glutaric, adipic, pimelic, suberic, azelaic, sebacic or dimerized or trimerized linoleic acid. Cycloaliphatic polycarboxylic acids are suitable, e.g. tetrahydrophthalic, 4-methyltetrahydrophthalic, hexahydrophthalic or 4-methylhexahydrophthalic acid.
   Aromatic polycarboxylic acids are suitable, such as phthalic, isophthalic, trimellitic and pyromellitic acid. Likewise suitable are carboxyl-terminated adducts of, for example, trimellitic acid and polyols such as glycerol or 2,2-bis(4-hydroxycyclohexyl)propane.
II) Polyglycidyl ethers or poly(β-methylglycidyl)ethers obtainable by reacting a compound having at least two free alcoholic hydroxyl groups and/or phenolic hydroxyl groups with a suitably substituted epichlorohydrin under alkaline conditions or in the presence of an acidic catalyst with subsequent treatment under alkaline conditions.
   Ethers of this type are derived, for example, from straight-chained alcohols, such as ethyleneglycol, diethyleneglycol and higher poly(oxyethylene)glycols, propane-1,2-diol, or poly(oxypropylene)glycols, propane-1,3-diol, butane-1,4-diol, poly(oxytetramethylene)glycols, pentane-1,5-diol, hexane-1,6-diol, hexane-2,4,6-triol, glycerol, 1,1,1-trimethylolpropane, bistrimethylolpropane, pentaerythritol, sorbitol, and from polyepichlorohydrins.
   In the alternative, they are derived, for example, from cycloaliphatic alcohols, such as 1,3- or 1,4-dihydroxycyclohexane, bis(4-hydroxycyclohexyl)methane, 2,2-bis(4-hydroxycyclohexyl)-propane or 1,1-bis(hydroxymethyl)cyclohex-3-ene, or they possess aromatic nuclei, such as N,N-bis(2-hydroxyethyl)aniline or p,p′-bis(2-hydroxyethylamino)diphenylmethane.
   The epoxy compounds may also be derived from mononuclear phenols, such as resorcinol or hydroquinone; or they are based on polynuclear phenols, such as bis(4-hydroxyphenyl)methane, 2,2-bis(4-hydroxyphenyl)propane, 2,2-bis(3,5-dibromo-4-hydroxyphenyl)-propane or 4,4′-dihydroxydiphenyl sulphone, or on condensates of phenols with formaldehyde that are obtained under acidic conditions, such as phenol Novolak®.
III) Poly(N-glycidyl) compounds obtainable by dehydrochlorinating the reaction products of epichlorohydrin with amines containing at least two amino hydrogen atoms. These amines are, for example, aniline, toluidine, n-butylamine, bis(4-aminophenyl)methane, m-xylylenediamine or bis(4-methylaminophenyl)methane, and also N,N,O-triglycidyl-m-aminophenol or N,N,O-triglycidyl-p-aminophenol.
   The poly(N-glycidyl) compounds also include N,N′-diglycidyl derivatives of cycloalkylene-urea, such as ethylene urea or 1,3-propyleneurea, and N,N′-diglycidyl derivatives of hydantoin, such as of 5,5-dimethylhydantoin.
IV) Poly(S-glycidyl) compounds, such as di-S-glycidyl derivatives derived from dithiols, such as ethane-1,2-dithiol or bis(4-mercaptomethylphenyl)ether.

Suitable epoxy compounds having a radical of the formula A, in which R₁ and R₃ together are —CH₂—CH₂— and n is 0 are bis(2,3-epoxycyclopentyl)ether, 2,3-epoxycyclopentyl glycidyl ether or 1,2-bis(2,3-epoxycyclopentyloxy)ethane. An example of an epoxy resin having a radical of the formula A in which R₁ and R₃ together are —CH₂—CH₂— and n is 1 is (3,4-epoxy-6-methylcyclohexyl)methyl 3′,4′-epoxy-6′-methylcyclohexanecarboxylate.

Polyfunctional epoxide compounds are known. Many of them are commercially available from Huntsman Advanced Materials (brand name Araldite®). Examples of suitable polyfunctional epoxides are:

a) Liquid bisphenol A diglycidyl ethers, such as ARALDITE GY 240, ARALDITE GY 250, ARALDITE GY 260, ARALDITE GY 266, ARALDITE GY 2600, ARALDITE MY 790;
b) Solid bisphenol A diglycidyl ethers such as ARALDITE GT 6071, ARALDITE GT 7071, ARALDITE GT 7072, ARALDITE GT 6063, ARALDITE GT 7203, ARALDITE GT 6064, ARALDITE GT 7304, ARALDITE GT 7004, ARALDITE GT 6084, ARALDITE GT 1999, ARALDITE GT 7077, ARALDITE GT 6097, ARALDITE GT 7097, ARALDITE GT 7008, ARALDITE GT 6099, ARALDITE GT 6608, ARALDITE GT 6609, ARALDITE GT 6610;
c) Liquid bisphenol F diglycidyl ethers, such as ARALDITE GY 281, ARALDITE GY 282, ARALDITE PY 302, ARALDITE PY 306;
d) Solid polyglycidyl ethers of tetraphenylethane, such as CG Epoxy Resin 0163;
e) Solid and liquid polyglycidyl ethers of phenol-formaldehyde Novolak®, such as EPN 1138, EPN 1139, GY 1180, PY 307;
f) Solid and liquid polyglycidyl ethers of o-cresol-formaldehyde NOVOLAK, such as ECN 1235, ECN 1273, ECN 1280, ECN 1299;
g) Liquid glycidyl ethers of alcohols, such as Shell glycidyl ether 162, ARALDITE DY 0390, ARALDITE DY 0391;
h) Liquid glycidyl ethers of carboxylic acids, such as Shell Cardura E terephthalic ester, trimellitic ester, ARALDITE PY 284;
i) Solid heterocyclic epoxy resins (triglycidyl isocyanurate), such as ARALDITE PT 810;
k) Liquid cycloaliphatic epoxy resins, such as ARALDITE CY 179;
l) Liquid N,N,O-triglycidyl ethers of p-aminophenol, such as ARALDITE MY 0510;
m) Tetraglycidyl-4,4′-methylenebenzamine or N,N,N′,N′-tetraglycidyldiaminophenylmethane, such as ARALDITE MY 720, ARALDITE MY 721.

If desired, a mixture of epoxy compounds of different structure can also be employed.

According to a preferred embodiment of the invention, the polymer chain extension agent of Component b) is selected from the group consisting of bisphenol A diglycidyl ethers, ethylene glycidyl methacrylate copolymers, styrene glycidyl methacrylate copolymers and ethylene acrylate glycidyl methacrylate terpolymers.

According to a particularly preferred embodiment, the polymer chain extension agent of Component b) is selected from the group consisting of bisphenol A diglycidyl ethers, such as liquid or solid bisphenol A diglycidyl ethers of the ARALDITE GY or GT series, a terpolymer comprising ethylene, butyl acrylate and methacrylate monomers, such as the products of the type Elvaloy® commercially available from E.I. DuPont de Nemours and Company, or a terpolymer comprising ethylene and methacrylate monomers, such as the products of the type ELVALOY AC.

According to a highly preferred embodiment, the polymer chain extension agent of Component b) is a low molecular weight styrene-acrylate epoxy copolymer of the Joncryl® type, particularly the JONCRYL ADR chain extension type, such as the commercially available products JONCRYL ADR-4368, 4370, 4300, 4385 and 4380.

### Component c)

A suitable oxide or hydroxide of a metal selected from the group consisting of alkali metals, earth alkaline metals, aluminium, titanium, zinc, antimony and bismuth is, for example, sodium or potassium hydroxide, magnesium, calcium or barium hydroxide, magnesium or calcium oxide, aluminium oxide hydroxide or trihydroxide, zinc oxide or antimony trioxide or the mixed oxides or hydroxides with carbonates, nitrates, sulphates, phosphates or carbonates.

According to a preferred embodiment, Component c) is an oxide of a metal selected from the group consisting of alkali metals and earth alkaline metals.

Component a) is preferably contained in the flame retardant compositions according to the invention in an amount from 0.1-45.0 wt. %, preferably 1-30.0 wt. %, based on the weight of a polymer substrate component. Component b) is preferably contained in an amount from 0.05-5.0 wt. %, preferably 0.1-2.0 wt. %. Component c) is preferably contained in an amount from 0.05-5.0 wt. %, preferably 0.1-2.0 wt. %. The sum of Components a), b) and c) is 100 wt. % based on the weight of a polymer component.

The preferred ratio of components a):b):c) is in the range 50:1:1-1:5:5, preferably 20:1:1-1:2:2.

A further embodiment of the invention relates to a mixture, which comprises
a) A salt of a phosphinic acid as represented by the structural formulae (I) or (II),
   In which
   one of R¹ and R² represents hydrogen or C₁-C₈alkyl; or both R¹ and R² represent C₁-C₈alkyl; and
   R³ represents C₁-C₁₀alkylene, C₂-C₁₀alkylene interrupted by phenylene, phenylene, (C₁-C₄alkyl)₁₋₃phenylene, or phenyl-C₁-C₄alkylene; and
b) At least one polymer chain extension agent on the basis of epoxide structures; and
c) An oxide or hydroxide of a metal selected from the group consisting of alkali metals, earth alkaline metals, aluminium, titanium, zinc, antimony and bismuth.

The mixture is particularly useful for imparting flame retardancy to a polymer substrate.

A further embodiment of the invention relates to a process for imparting flame retardancy to a polymer substrate, which process comprises adding to a polymer substrate the above defined mixture of components a), b) and c) and d) and e) as optional components.

### Additional Components

According to a preferred embodiment, the composition additionally comprises
d) An alkali metal or earth alkaline metal salt of an organic carboxylic acid.

According to a preferred embodiment Component d) is a salt of metal selected from the group consisting of alkali metals, earth alkaline metals, aluminium, titanium and zinc with a straight chain C₁₄-C₄₀alkyl carboxylic acid.

According to a particularly preferred embodiment Component d) is a salt of metal selected from the group consisting of sodium, calcium, barium, aluminium and zinc with stearic acid.

A suitable alkali metal or earth alkaline metal salt of an organic carboxylic acid is, for example, the aluminium, magnesium, sodium, potassium, calcium, zinc or barium salt of a saturated C₁₀-C₄₀carboxylic acid, such as lauric (C-12), myristic (C-14), palmitic (C-16), stearic (C-18) or nonadecanoic (C-19) acid or carboxylic acid with a higher number of C-atoms, such as icosanoic, arachidonic, docosanoic, behenoic acid or montanoic acid.

The instant invention further pertains to a composition, which comprises, in addition to the components a), b) and c), as defined above, as optional components, additional flame retardants and further additives selected from the group consisting of so-called anti-dripping agents and polymer stabilizers.

Representative additional flame retardants are, for example:

Tetraphenyl resorcinol diphosphate (Fyrolflex® RDP, Akzo Nobel), resorcinol diphosphate oligomer (RDP), triphenyl phosphate, tris(2,4-di-tert-butylphenyl)phosphate, ethylenediamine diphosphate (EDAP), ammonium polyphosphate, diethyl-N,N-bis(2-hydroxyethyl)-aminomethyl phosphonate, hydroxyalkyl esters of phosphorus acids, tetrakis(hydroxymethyl)phosphonium sulphide, triphenylphosphine, derivatives of 9,10-dihydro-9-oxa-10-phosphorylphenanthrene-10-oxide (DOPO), and phosphazene flame-retardants as well as nitrogen or halogen containing flame retardants.

Nitrogen containing flame retardants are, for example, isocyanurate flame retardants, such as polyisocyanurate, esters of isocyanuric acid or isocyanurates. Representative examples are hydroxyalkyl isocyanurates, such as tris-(2-hydroxyethyl)isocyanurate, tris(hydroxymethyl)isocyanurate, tris(3-hydroxy-n-proyl)isocyanurate or triglycidyl isocyanurate.

Nitrogen containing flame-retardants include further melamine-based flame-retardants. Representative examples are: melamine cyanurate, such as the commercial product MelapurOMC, or other melamine derivatives, such as melamine borate, melamine phosphate, melamine pyrophosphate, melamine polyphosphate, melamine ammonium polyphosphate, melamine ammonium pyrophosphate, dimelamine phosphate and dimelamine pyrophosphate.

A preferred embodiment of the invention relates to a composition, which comprises as an additional flame retardant a 1,3,5-triazine compound, wherein the number n of the average degree of condensation is higher than 20 and the 1,3,5-triazine content amounts to more than 1.1 mol of 1,3,5-triazine compound per mol of phosphorus atom.

A suitable 1,3,5-triazine compound is melamine or the condensed products thereof, such as melamine, melam, melem, melon or mixtures thereof.

According to a preferred embodiment, the n-value is between 20 and 200 and the triazine content amounts to 1.1 to 2.0 mol per mol of phosphorus atom. Flame retardant compositions that contain these compounds are commercially available, such as the product Melapur®200, or can be obtained by known methods, such as the ones described in the European Patent No. 1 095 030.

A particularly preferred embodiment of the invention relates to a composition, which comprises as an additional flame retardant melamine, wherein the number n of the average degree of condensation is higher than 20 and the melamine content amounts to more than 1.1 mol of melamine per mol of phosphorus atom.

Further examples of nitrogen containing flame-retardants are: benzoguanamine, tris(hydroxyethyl)isocyanurate, allantoin, glycoluril, melamine cyanurate, melamine phosphate, dimelamine phosphate, urea cyanurate, ammonium polyphosphate, a condensation product of melamine from the series melem, melam, melon and/or a higher condensed compound or a reaction product of melamine with phosphoric acid or a mixture thereof.

Representative organohalogen flame retardants are, for example:

Polybrominated diphenyl oxide (DE-60F, Great Lakes Corp.), decabromodiphenyl oxide (DBDPO; Saytex® 102E), tris[3-bromo-2,2-bis(bromomethyl)propyl]phosphate (PB 370®, FMC Corp.), tris(2,3-dibromopropyl)phosphate, tris(2,3-dichloropropyl)phosphate, chlorendic acid, tetrachlorophthalic acid, tetrabromophthalic acid, poly-α-chloroethyl triphosphonate mixture, tetrabromobisphenol A bis(2,3-dibromopropyl ether) (PE68), brominated epoxy resin, ethylene-bis(tetrabromophthalimide) (Saytex® BT-93), bis(hexachlorocyclopentadieno)cyclooctane (Declorane Plus®), chlorinated paraffins, octabromodiphenyl ether, hexachlorocyclopentadiene derivatives, 1,2-bis(tribromophenoxy)ethane (FF680), tetrabromo-bisphenol A (Saytex® RB100), ethylene bis(dibromo-norbornanedicarboximide) (Saytex® BN-451), bis-(hexachlorocycloentadeno)cyclooctane, PTFE, tris-(2,3-dibromopropyl)-isocyanurate, and ethylene-bis-tetrabromophthalimide.

The organohalogen flame retardants mentioned above are routinely combined with an inorganic oxide synergist. Most common for this use are zinc or antimony oxides, e.g. Sb₂O₃ or Sb₂O₅. Boron compounds are suitable, too.

Representative inorganic flame retardants include, for example, aluminium trihydroxide (ATH), boehmite (AIOOH), magnesium dihydroxide (MDH), zinc borates, CaCO₃, (organically modified) layered silicates, (organically modified) layered double hydroxides, and mixtures thereof.

According to a preferred embodiment, the composition comprises as an additional flame retardant a nitrogen containing compound selected from the group consisting of melamine polyphosphate, ammonium polyphosphate, melamine ammonium phosphate, polyphosphate or pyrophosphate, a condensation product of melamine with phosphoric acid and other reaction products of melamine with phosphoric acid and mixtures thereof.

The above-mentioned additional flame retardant classes are advantageously contained in the composition of the invention in an amount from about 0.5% to about 60.0% by weight of the organic polymer substrate; for instance about 1.0% to about 40.0%; for example about 5.0% to about 35.0% by weight of the polymer or based on the total weight of the composition.

According to another embodiment, the invention relates to a composition which additionally comprises as additional component so-called anti-dripping agents.

These anti-dripping agents reduce the melt flow of the thermoplastic polymer and inhibit the formation of drops at high temperatures. Various references, such as U.S. Pat. No. 4,263,201, describe the addition of anti-dripping agents to flame retardant compositions.

Suitable additives that inhibit the formation of drops at high temperatures include glass fibres, polytetrafluoroethylene (PTFE), high temperature elastomers, carbon fibres, glass spheres and the like.

The addition of polysiloxanes of different structures has been proposed in various references; cf. U.S. Pat. No. 6,660,787, 6,727,302 or 6,730,720.

Stabilizers are preferably halogen-free and selected from the group consisting of nitroxyl stabilizers, intone stabilizers, amine oxide stabilizers, benzofuranone stabilizers, phosphite and phosphonite stabilizers, quinone methide stabilizers and monoacrylate esters of 2,2′-alkylidenebisphenol stabilizers.

As mentioned above, the composition according to the invention may additionally contain one or more conventional additives, for example selected from pigments, dyes, plasticizers, antioxidants, thixotropic agents, levelling assistants, basic co-stabilizers, metal passivators, metal oxides, organophosphorus compounds, further light stabilizers and mixtures thereof, especially pigments, phenolic antioxidants, calcium stearate, zinc stearate, UV absorbers of the 2-hydroxy-benzophenone, 2-(2′-hydroxyphenyl)benzotriazole and/or 2-(2-hydroxyphenyl)-1,3,5-triazine groups.

Preferred additional additives for the compositions as defined above are processing stabilizers, such as the above-mentioned phosphites and phenolic antioxidants, and light stabilizers, such as benzotriazoles. Preferred specific antioxidants include octadecyl 3-(3,5-di-tert-butyl-4-hydroxyphenyl)propionate (I RGANOX 1076), pentaerythritoltetrakis[3-(3,5-di-tert-butyl-4-hydroxyphenyl)propionate] (IRGANOX 1010), tris(3,5-di-tert-butyl-4-hydroxyphenyl)isocyanurate (IRGANOX 3114), 1,3,5-trimethyl-2,4,6-tris(3,5-di-tert-butyl-4-hydroxybenzyl)benzene (I RGANOX 1330), triethyleneglycol-bis[3-(3-tert-butyl-4-hydroxy-5-methylphenyl)propionate] (IRGANOX 245), and N,N′-hexane-1,6-diyl-bis[3-(3,5-di-tert-butyl-4-hydroxyphenyl)propionamide] (IRGANOX 1098). Specific processing stabilizers include tris(2,4-di-tert-butylphenyl)phosphite (IRGAFOS 168), 3,9-bis(2,4-di-tert-butylphenoxy)-2,4,8,10-tetraoxa-3,9-diphosphaspiro-[5.5]undecane (IRGAFOS 126), 2,2′,2″-nitrilo[triethyl-tris(3,3′,5,5′-tetra-tert-butyl-1,1′-biphenyl-2,2′-diyl)]phosphite (IRGAFOS 12), and tetrakis(2,4-di-tert-butylphenyl)[1,1-biphenyl]-4,4′-diylbisphosphonite (IRGAFOS P-EPQ). Specific light stabilizers include 2-(2H-benzotriazole-2-yl)-4,6-bis(1-methyl-1-phenylethyl)phenol (TINUVIN 234), 2-(5-chloro(2H)-benzotriazole-2-yl)-4-(methyl)-6-(tert-butyl)phenol (TINUVIN 326), 2-(2H-benzotriazole-2-yl)-4-(1,1,3,3-tetramethylbutyl)phenol (TINUVIN 329), 2-(2H-benzotriazole-2-yl)-4-(tert-butyl)-6-(sec-butyl)phenol (TINUVIN 350), 2,2′-methylenebis(6-(2H-benzotriazol-2-yl)-4-(1,1,3,3-tetramethylbutyl)phenol) (TINUVIN 360), and 2-(4,6-diphenyl-1,3,5-triazin-2-yl)-5-[(hexyl)oxy]-phenol (TINUVIN 1577), 2-(2′-hydroxy-5′-methylphenyl)benzotriazole (TINUVIN P), 2-hydroxy-4-(octyloxy)benzophenone (CHIMASSORB 81), 1,3-bis-[(2′-cyano-3′,3′-diphenylacryloyl)oxy]-2,2-bis-{[(2′-cyano-3′,3′-diphenylacryloyl)oxy]methyl}-propane (UVINUL 3030, BASF), ethyl-2-cyano-3,3-diphenylacrylate (UVINUL 3035, BASF), and (2-ethylhexyl)-2-cyano-3,3-diphenylacrylate (UVINUL 3039, BASF).

The additives mentioned above are preferably contained in an amount of 0.01 to 10.0%, especially 0.05 to 5.0%, relative to the weight of the polymer substrate of Component c).

According to a preferred embodiment the composition comprises as additional component
e) A polymer substrate.

The term polymer substrate comprises within its scope thermoplastic polymers or thermosets.

A list of suitable thermoplastic polymers is given below:
1. Polymers of monoolefins and diolefins, for example polypropylene, polyisobutylene, polybut-1-ene, poly-4-methylpent-1-ene, polyvinylcyclohexane, polyisoprene or polybutadiene, as well as polymers of cycloolefins, for instance of cyclopentene or norbornene, polyethylene (which optionally can be cross linked), for example high density polymethylene (HDPE), high density and high molecular weight polyethylene (HDPE-HMW), high density and ultrahigh molecular weight polyethylene (HDPE-UHMVV), medium density polyethylene (MDPE), low density polyethylene (LDPE), linear low density polyethylene (LLDPE), (VLDPE) and (ULDPE).
2. Mixtures of the polymers mentioned under 1), for example mixtures of polypropylene with polyisobutylene, polypropylene with polyethylene (for example PP/HDPE, PP/LDPE) and mixtures of different types of polyethylene (for example LDPE/HDPE).
3. Copolymers of monoolefins and diolefins with each other or with other vinyl monomers, for example ethylene/propylene copolymers, linear low density polyethylene (LLDPE) and mixtures thereof with low density polyethylene (LDPE), propylene/but-1-ene copolymers, propylene/isobutylene copolymers, ethylene/but-1-ene copolymers, ethylene/hexene copolymers, ethylene/methylpentene copolymers, ethylene/heptene copolymers, ethylene/octene copolymers, ethylene/vinylcyclohexane copolymers, ethylene/cycloolefin copolymers (e.g. ethylene/norbornene like COC), ethylene/1-olefins copolymers, where the 1-olefin is generated in-situ; propylene/butadiene copolymers, isobutylene/isoprene copolymers, ethylene/vinylcyclohexene copolymers, ethylene/alkyl acrylate copolymers, ethylene/alkyl methacrylate copolymers, ethylene/vinyl acetate copolymers or ethylene/acrylic acid copolymers and their salts (ionomers) as well as terpolymers of ethylene with propylene and a diene such as hexadiene, dicyclopentadiene or ethylidene-norbornene; and mixtures of such copolymers with one another and with polymers mentioned in 1) above, for example polypropylene/ethylene-propylene copolymers, LDPE/ethylene-vinyl acetate copolymers (EVA), LDPE/ethylene-acrylic acid copolymers (EAA), LLDPE/EVA, LLDPE/EAA and alternating or random polyalkylene/carbon monoxide copolymers and mixtures thereof with other polymers, for example polyamides.
4. Hydrocarbon resins (for example C₅-C₉) including hydrogenated modifications thereof (e.g. tackifiers) and mixtures of polyalkylenes and starch;
   The homopolymers and copolymers mentioned above may have a stereo structure including syndiotactic, isotactic, hemi-isotactic or atactic; where atactic polymers are preferred. Stereo block polymers are also included.
5. Polystyrene, poly(p-methylstyrene).
6. Aromatic homopolymers and copolymers derived from vinyl aromatic monomers including styrene, α-methylstyrene, all isomers of vinyl toluene, especially p-vinyl toluene, all isomers of ethyl styrene, propyl styrene, vinyl biphenyl, vinyl naphthalene, and vinyl anthracene, and mixtures thereof. Homopolymers and copolymers may have a stereo structure including syndiotactic, isotactic, hemi-isotactic or atactic; where atactic polymers are preferred. Stereo block polymers are also included;
   a) Copolymers including aforementioned vinyl aromatic monomers and comonomers selected from ethylene, propylene, dienes, nitriles, acids, maleic anhydrides, maleimides, vinyl acetate and vinyl chloride or acrylic derivatives and mixtures thereof, for example styrene/butadiene, styrene/acrylonitrile, styrene/ethylene (interpolymers), styrene/alkyl methacrylate, styrene/butadiene/alkyl acrylate, styrene/butadiene/alkyl methacrylate, styrene/maleic anhydride, styrene/acrylonitrile/methyl acrylate; mixtures of high impact strength of styrene copolymers and another polymer, for example a polyacrylate, a diene polymer or an ethylene/propylene/diene terpolymer; and block copolymers of styrene such as styrene/butadiene/styrene, styrene/isoprene/styrene, styrene/ethylene/butylene/styrene or styrene/ethylene/propylene/styrene.
   b) Hydrogenated aromatic polymers derived from hydrogenation of polymers mentioned under 6.), especially including polycyclohexylethylene (PCHE) prepared by hydrogenating atactic polystyrene, often referred to as polyvinylcyclohexane (PVCH).
   c) Hydrogenated aromatic polymers derived from hydrogenation of polymers mentioned under 6a). Homopolymers and copolymers may have a stereo structure including syndiotactic, isotactic, hemi-isotactic or atactic; where atactic polymers are preferred. Stereo block polymers are also included.
7. Graft copolymers of vinyl aromatic monomers such as styrene or α-methylstyrene, for example styrene on polybutadiene, styrene on polybutadiene-styrene or polybutadiene-acrylonitrile copolymers; styrene and acrylonitrile (or methacrylonitrile) on polybutadiene; styrene, acrylonitrile and methyl methacrylate on polybutadiene; styrene and maleic anhydride on polybutadiene; styrene, acrylonitrile and maleic anhydride or maleimide on polybutadiene; styrene and maleimide on polybutadiene; styrene and alkyl acrylates or methacrylates on polybutadiene; styrene and acrylonitrile on ethylene/propylene/diene terpolymers; styrene and acrylonitrile on polyalkyl acrylates or polyalkyl methacrylates, styrene and acrylonitrile on acrylate/butadiene copolymers, as well as mixtures thereof with the copolymers listed under 6), for example the copolymer mixtures known as ABS, MBS, ASA or AES polymers.
8. Halogen-containing polymers such as polychloroprene, chlorinated rubbers, chlorinated and brominated copolymer of isobutylene-isoprene (halobutyl rubber), chlorinated or sulphochlorinated polyethylene, copolymers of ethylene and chlorinated ethylene, epichlorohydrin homo- and copolymers, especially polymers of halogen-containing vinyl compounds, for example polyvinyl chloride, polyvinylidene chloride, polyvinyl fluoride, polyvinylidene fluoride, as well as copolymers thereof such as vinyl chloride/vinylidene chloride, vinyl chloride/vinyl acetate or vinylidene chloride/vinyl acetate copolymers.
9. Polymers derived from α,β-unsaturated acids and derivatives thereof such as polyacrylates and polymethacrylates; polymethyl methacrylates, polyacrylamides and polyacrylonitriles, impact-modified with butyl acrylate.
10. Copolymers of the monomers mentioned under 9) with each other or with other unsaturated monomers, for example acrylonitrile/butadiene copolymers, acrylonitrite/alkyl acrylate copolymers, acrylonitrile/alkoxyalkyl acrylate or acrylonitrile/vinyl halide copolymers or acrylonitrile/alkyl methacrylate/butadiene terpolymers.
11. Polymers derived from unsaturated alcohols and amines or the acyl or acetal derivatives thereof, for example polyvinyl alcohol, polyvinyl acetate, polyvinyl stearate, polyvinyl benzoate, polyvinyl maleate, polyvinyl butyral, polyallyl phthalate or polyallyl melamine; as well as their copolymers with olefins mentioned in 1 above.
12. Homopolymers and copolymers of cyclic ethers such as polyalkylene glycols, polyethylene oxide, polypropylene oxide or copolymers thereof with bisglycidyl ethers.
13. Polyacetals such as polyoxymethylene and those polyoxymethylenes, which contain ethylene oxide as a co-monomer; polyacetals modified with thermoplastic polyurethanes, acrylates or MBS.
14. Polyphenylene oxides and sulphides, and mixtures of polyphenylene oxides with styrene polymers or polyamides.
15. Polyurethanes derived from hydroxyl-terminated polyethers, polyesters or polybutadienes on the one hand and aliphatic or aromatic polyisocyanates on the other, as well as precursors thereof.
16. Polyamides and co-polyamides derived from diamines and dicarboxylic acids and/or from aminocarboxylic acids or the corresponding lactams, for example polyamide 4, polyamide 6, polyamide 6/6, 6/10, 6/9, 6/12, 4/6, 12/12, polyamide 11, polyamide 12, PA 6T, PAXD6, PA 6T/66, PA 4T, aromatic polyamides starting from m-xylene diamine and adipic acid; polyamides prepared from hexamethylenediamine and isophthalic or/and terephthalic acid and with or without an elastomer as modifier, for example poly-2,4,4,-trimethylhexamethylene terephthalamide or poly-m-phenylene isophthalamide; and also block copolymers of the aforementioned polyamides with polyolefins, olefin copolymers, ionomers or chemically bonded or grafted elastomers; or with polyethers, e.g. with polyethylene glycol, polypropylene glycol or polytetramethylene glycol; as well as polyamides or co-polyamides modified with EPDM or ABS; and polyamides condensed during processing (RIM polyamide systems).
17. Polyureas, polyimides, polyamide imides, polyether imides, polyester imides, polyhydantoins and polybenzimidazoles.
18. Polyesters derived from dicarboxylic acids and diols and/or from hydroxycarboxylic acids or the corresponding lactones, for example polyethylene terephthalate, polypropylene terephthalate (PPT), polybutylene terephthalate (PBT), poly-1,4-dimethylolcyclohexane terephthalate, polyalkylene naphthalate (PAN) and polyhydroxybenzoates, as well as block co-polyether esters derived from hydroxyl-terminated polyethers; and also polyesters modified with polycarbonates or MBS.
19. Polyketones.
20. Polysulphones, polyether sulphones and polyether ketones.
21. Blends of the aforementioned polymers (polyblends), for example PP/EPDM, Polyamide/EPDM or ABS, PVC/EVA, PVC/ABS, PVC/MBS, PC/ABS, PBTP/ABS, PC/ASA, PC/PBT, PVC/CPE, PVC/acrylates, POM/thermoplastic PUR, PC/thermoplastic PUR, POM/acrylate, POM/MBS, PPO/HIPS, PPO/PA 6.6 and copolymers, PA/HDPE, PA/PP, PA/PPO, PBT/PC/ABS or PBT/PET/PC.
22. Polycarbonates that correspond to the general formula:

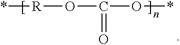

Such Polycarbonates are obtainable by interfacial processes or by melt processes (catalytic transesterification). The polycarbonate may be either branched or linear in structure and may include any functional substituents. Polycarbonate copolymers and polycarbonate blends are also within the scope of the invention. The term polycarbonate should be interpreted as inclusive of copolymers and blends with other thermoplastics. Methods for the manufacture of polycarbonates are known, for example, from U.S. Pat. Nos. 3,030,331; 3,169,121; 4,130,458; 4,263,201; 4,286,083; 4,552,704; 5,210,268; and 5,606,007. A combination of two or more polycarbonates of different molecular weights may be used.
Preferred are polycarbonates obtainable by reaction of a diphenol, such as bisphenol A, with a carbonate source. Examples of suitable diphenols are:
Bisphenol A, AF, AP, B, C, E, F, M, P, S, TMC, Z, 4,4′-(2-norbornylidene)bis(2,6-dichlorophenol) or fluorene-9-bisphenol.
The carbonate source may be a carbonyl halide, a carbonate ester or a haloformate. Suitable carbonate halides are phosgene or carbonyl bromide. Suitable carbonate esters are dialkylcarbonates, such as dimethyl- or diethylcarbonate, diphenyl carbonate, phenyl-alkylphenylcarbonate, such as phenyl-tolylcarbonate, dialkylcarbonates, such as dimethyl- or diethylcarbonate, di-(halophenyl)carbonates, such as di-(chlorophenyl)carbonate, di-(bromophenyl)carbonate, di(trichlorophenyl)carbonate or di-(trichlorophenyl)carbonate, di-(alkylphenyl)carbonates, such as di-tolylcarbonate, naphthyl carbonate, dichloronaphthyl carbonate and others.
The polymer substrate mentioned above, which comprises polycarbonates or polycarbonate blends is a polycarbonate-copolymer, wherein isophthalate/terephthalate-resorcinol segments are present. Such polycarbonates are commercially available, e.g. Lexan® SLX (General Electrics Co. USA). Other polymeric substrates of component b) may additionally contain in the form as admixtures or as copolymers a wide variety of synthetic polymers including polyolefins, polystyrenes, polyesters, polyethers, polyamides, poly(meth)acrylates, thermoplastic polyurethanes, polysulphones, polyacetals and PVC, including suitable compatibilizing agents. For example, the polymer substrate may additionally contain thermoplastic polymers selected from the group of resins consisting of polyolefins, thermoplastic polyurethanes, styrene polymers and copolymers thereof. Specific embodiments include polypropylene (PP), polyethylene (PE), polyamide (PA), polybutylene terephthalate (PBT), polyethylene terephthalate (PET), glycol-modified polycyclohexylenemethylene terephthalate (PCTG), polysulphone (PSU), polymethyl-methacrylate (PMMA), thermoplastic polyurethane (TPU), acrylonitrile-butadiene-styrene (ABS), acrylonitrile-styrene-acrylic ester (ASA), acrylonitrile-ethylene-propylene-styrene (AES), styrene-maleic anhydride (SMA) or high impact polystyrene (HIPS).

A preferred embodiment of the invention relates to compositions which comprise as component e) thermoplastic polymers. Preferred thermoplastic polymers include polyolefin homo- and copolymers, copolymers of olefin vinyl monomers, styrenic homopolymers and copolymers thereof, polyesters and polyamides.

Advantageously, the Components a) and b) are ground to a fine powder with an average particle size below 100 μm prior to their application in polymer substrates as it is observed that the flame retardant properties of the inventive compositions are improved by small particle sizes.

The incorporation of the components defined above into the polymer component is carried out by known methods such as dry blending in the form of a powder. The additive components a) and b) and optional further additives may be incorporated, for example, before or after molding. They may be added directly into the processing apparatus (e.g. extruders, internal mixers, etc.), e.g. as a dry mixture or powder.

The addition of the additive components to the polymer substrate can be carried out in customary mixing machines in which the polymer is melted and mixed with the additives. Suitable machines are known to those skilled in the art. They are predominantly mixers, kneaders and extruders.

The process is preferably carried out in an extruder by introducing the additive during processing.

Particularly preferred processing machines are single-screw extruders, contra-rotating and co-rotating twin-screw extruders, planetary-gear extruders, ring extruders or co-kneaders. Processing machines provided with at least one gas removal compartment can be used to which a vacuum can be applied.

Suitable extruders and kneaders are described, for example, in Handbuch der Kunststoffextrusion, Vol. 1 Grundlagen, Editors F. Hensen, W. Knappe, H. Potente, 1989, pp. 3-7, ISBN:3-446-14339-4 (Vol. 2 Extrusionsanlagen 1986, ISBN 3-446-14329-7).

For example, the screw length is 1-60 screw diameters, preferably 35-48 screw diameters. The rotational speed of the screw is preferably 10-600 rotations per minute (rpm), preferably 25-300 rpm.

The maximum throughput is dependent on the screw diameter, the rotational speed and the driving force. The process of the present invention can also be carried out at a level lower than maximum throughput by varying the parameters mentioned or employing weighing machines delivering dosage amounts.

If a plurality of components is added, these can be premixed or added individually.

The additive components a) and b) optional further additives can also be added to the polymer in the form of a master batch (“concentrate”) which contains the components in a concentration of, for example, about 1.0% to about 40.0% and preferably 2.0% to about 20.0% by weight incorporated in a polymer. The polymer is not necessarily of identical structure than the polymer where the additives are added finally. In such operations, the polymer can be used in the form of powder, granules, solutions, and suspensions or in the form of lattices.

Incorporation can take place prior to or during the shaping operation. The materials containing the additives of the invention described herein preferably are used for the production of molded articles, for example roto-molded articles, injection molded articles, profiles and the like, and especially a fibre, spun melt non-woven, film or foam.

A preferred embodiment of the invention relates to a composition, which comprises
a) At least one salt of a phosphinic acid (I) as represented by the formula

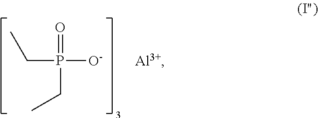

b) A polymer chain extension agent of the low molecular weight styrene-acrylate epoxy copolymer type;
c) At least one oxide of a metal selected from the group consisting of alkali metals and earth alkaline metals; and
d) An alkali metal or earth alkaline metal salt of an organic carboxylic acid; and, optionally,
e) A polymer substrate.

The following Examples illustrate the invention:

### Materials and Methods

Polymer Component (pellets):

UltradurOB 4300 G4 (BASF SE): Polybutylene terephthalate containing 20 wt.-% glass fibres (PBT GF);
Flame Retardant Components (in powder form):
Exolit OP® 1240 (Clariant Switzerland): Diethylphosphinic acid aluminium salt (DEPAL);
Melapur® 200 70 (BASF SE): Melamine polyphosphate (MPP);
Calcium oxide (Sigma Aldrich, CaO);
Sodium stearate (Fluka Chemie AG, Switzerland);
Joncryl® ADR-4368 (BASF SE): polymeric chain extender;
Elvaloy® 1820 AC (Dupont), ethylene-methylene-acrylate copolymer (EMA);
Araldite® GT 7072 (Huntsman): epoxy resin; chain extender
Irganox® 1010 (BASF SE): phenolic antioxidant;
Irgafos® 168 (BASF SE): phosphite, process stabilizer;

Referential and Inventive Compositions are compounded in a twin screw extruder (Berstorff 25/46) at temperatures of 250°-270° C. The homogenized polymer strand is taken off, cooled in water bath and cut into pellets. PBT and DEPAL are added in with separate dosing units into the extruder. The other components are premixed in the amounts as indicated and then dosed to the extruder.

UL94-V test specimen with 0.8 mm thickness are prepared by injection molding (Engel EK 65).

UL 94 test for “Flammability of Plastic Materials for Parts in Devices and Appliances”, 5^{th} edition, Oct. 29, 1996. Ratings according to the UL 94 V test are compiled in the following table (time periods are indicated for one specimen):

| Rating | After flame time [sec] | Burning drips | Burn to clamp |
|---|---|---|---|
| V-0 | <10 | No | No |
| V-1 | <30 | No | No |
| V-2 | <30 | Yes | No |
| n.c. | <30 | | Yes |
| n.c. | >30 | | No |

n.c.: No classification

The flow properties of the final compounds is determined by measurement of the melt volume rate (MVR) according to ISO 1133 at 275° C. and 2.16 kg.

The property of Izod Impact Strength, notched, is determined according to DIN EN ISO 180. This reference number is a standardized high strain-rate test which determines the amount of energy absorbed by a material during fracture. This absorbed energy is a measure of a given material's toughness. A low Izod Impact Strength for compositions with practically identical content of polymer, glass fibres and flame retardants, indicates that the polymer matrix is partially decomposed.

The degree of corrosion is determined with the plaque method which is a useful model for comparative analysis of the intensity of corrosive and abrasive behaviour of polymer melts.

The test device consists of two test specimen formed of steel ST 37 arranged in pairs in a die thus forming for the polymer melt a rectangular passage slit of 12 mm length, 16 mm width and 0.4 mm height. The polymer melt is fed through the slit by an extruder thus producing in the slit a high degree of local shear stress and shear rate. The abrasion is described by measuring the weight loss of the test specimen with an analytical balance and an accuracy of 1 mg.

The weighing of the test specimen is carried out before and after the corrosion test with a throughput of 11 kg polymer. The sample bodies are removed from the nozzle and cleaned from adherent polymer in two steps. The hot polymer is removed by rubbing with soft tissue (cotton). The subsequent cleaning step is carried out by heating the test specimens for 25 min. at 60° C. in a 1:1 mixture of dichlorobenzene and phenol. The remaining polymer is removed by rubbing with a soft cloth of cotton.

To ensure the comparability of the test results obtained, all measurements from each test series are carried out under identical conditions (temperature programs, screw design, injection molding and test parameters etc.). Unless indicated otherwise, unspecified percentage amounts apply to percent by weight.

### Results

The results are reported in the TABLE below:

TABLE

| | Ref. | Ref. | Ref. | | Ref. | Ref. | | | Inv. | | |
|---|---|---|---|---|---|---|---|---|---|---|---|
| | Ex. 1 | Ex. 2 | Ex. 3 | Ref. Ex. 4 | Ex. 5 | Ex. 6 | Inv. Ex. 1 | Inv. Ex. 2 | Ex. 3 | Inv. Ex. 4 | Inv. Ex. 5 |
| PBT with 20% GF | 80.0 | 79.9 | 79.5 | 79.5 | 79.4 | 79.4 | 78.9 | 79.2 | 77.2 | 79.6 | 77.6 |
| Exolit OP 1240 | 13.0 | 13.0 | 13.0 | 13.0 | 13.0 | 13.0 | 13.0 | 13.0 | 13.0 | 13.0 | 13.0 |
| MELAPUR 200 70 | 7.0 | 7.0 | 7.0 | 7.0 | 7.0 | 7.0 | 7.0 | 7.0 | 7.0 | 7.0 | 7.0 |
| Ca-oxide | | 0.06 | | | 0.06 | 0.06 | 0.06 | 0.06 | 0.06 | 0.05 | 0.05 |
| Na-stearate | | | 0.5 | | 0.5 | | 0.5 | 0.5 | 0.5 | | |
| Ca-stearate | | | | | | | | | | 0.01 | 0.01 |
| Joncryl ® ADR 4368 | | | | 0.5 | | 0.5 | 0.5 | 0.25 | 0.25 | | |
| Araldite ® GT 7072 | | | | | | | | | | 0.35 | 0.35 |
| Elvaloy ® 1820 AC | | | | | | | | | 2.0 | | 2.00 |
| LDPE | | | | | | | | | | 0.02 | 0.02 |
| Irganox ® 1010 | | | | | | | | | | 0.034 | 0.034 |
| Irgafos ® 168 | | | | | | | | | | 0.034 | 0.034 |
| Corrosion | strong | low | medium | strong | low | low | low | low | low | low | low |
| UL 94 V at 0.8 mm | V-0 | V-0 | V-0 | V-0 | V-0 | V-0 | V-0 | V-0 | V-0 | V-0 | V-0 |
| Impact strength notched | 5.0 | 3.6 | 4.8 | 3.0 | 4.3 | 4.0 | 5.3 | 5.5 | 5.8 | 4.7 | 5.0 |
| Izod [kJ/m2] | | | | | | | | | | | |
| MVR at 275° C./2.16 kg | 35 | 161 | 43 | 111 | 132 | 53 | 35 | 57 | 44 | 71 | 77 |

### Comments

Referential Examples 1-6 represent State of the Art compositions tested for comparative purposes.
Ref. Ex. 1: Strong corrosion;
Ref. Ex. 2: Addition of calcium oxide, low corrosion, impact strength considerably lower, MVR considerably higher;
Ref. Ex. 3: Addition of sodium stearate, slight reduction of corrosion;
Ref. Ex. 4: Addition of JONCRYL, strong corrosion, impact strength considerably lower, MVR considerably higher;
Ref. Ex. 5: Addition of calcium oxide and sodium stearate, low corrosion, impact strength considerably lower, MVR considerably higher;
Ref. Ex. 6: Addition of calcium oxide and JONCRYL, low corrosion, Impact strength lower, MVR higher.

Inventive Examples 1-5 represent some inventive compositions, as claimed.
Inv. Ex. 1: Addition of calcium oxide, sodium stearate and JONCRYL, low corrosion, impact strength higher, no change of MVR;
Inv. Ex. 2: Addition of calcium oxide, sodium stearate and JONCRYL, low corrosion, impact strength higher, MVR slightly increased caused by addition of half amount of JONCRYL;
Inv. Ex. 3: Variation of Ex. 2, ELVALOY added, results in an increase of MVR;
Inv. Ex. 4: Addition of ARALDITE, calcium oxide, sodium stearate and JONCRYL, low corrosion, impact strength lower, MVR higher;
Inv. Ex. 5: Addition of ARALDITE, calcium oxide, sodium stearate, JONCRYL and additional ELVALOY, low corrosion, impact strength similar, MVR higher.

1. A composition, which comprises
a) A salt of a phosphinic acid of formula I or II 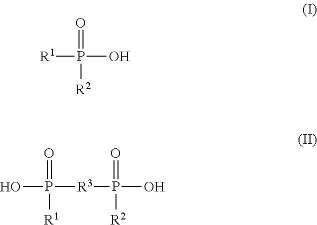
Wherein
R¹ and R² represent hydrogen or a linear or branched C₁-C₈alkyl radical or a phenyl radical; and
R³ represents a linear or branched C₁-C₁₀alkylene, arylene, alkylarylene or arylalkylene radical;
b) At least one polymer chain extension agent on the basis of epoxide structures; and
c) An oxide or hydroxide of a metal selected from the group consisting of alkali metals, earth alkaline metals, aluminium, titanium, zinc, antimony and bismuth.

2. A composition according to claim 1, which additionally comprises
d) An alkali metal or earth alkaline metal salt of an organic carboxylic acid.

3. A composition according to claim 1, which additionally comprises
e) A polymer substrate.

4. A composition according to claim 1, which additionally comprises further additives selected from the group consisting of polymer stabilizers and additional flame retardants.

5. A composition according to claim 1, which comprises an additional nitrogen containing flame retardant selected from the group consisting of melamine polyphosphate, ammonium polyphosphate, melamine ammonium phosphate, melamine ammonium polyphosphate, melamine ammonium pyrophosphate, a condensation product of melamine with phosphoric acid, other reaction products of melamine with phosphoric acid and mixtures thereof.

6. (canceled)

7. A composition according to claim 5, which comprises as an additional flame retardant a condensation product of melamine with phosphoric acid wherein the number n of the average degree of condensation is higher than 20 and the melamine content amounts to more than 1.1 mol of melamine per mol of phosphorus atom.

8. A composition according to claim 1, comprising a) a phosphinic acid salt of formula (I′) 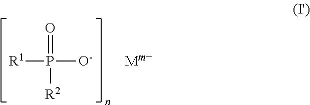
In which
one of R¹ and R² represents hydrogen or C₁-C₈alkyl; or both R¹ and R² represent C₁-C₈alkyl;
M represents (C₁-C₄alkyl)₄N, (C₁-C₄alkyl)₃NH, (C₂-C₄alkylOH)₄N, (C₂-C₄alkylOH)₃NH, (C₂-C₄alkylOH)₂N(CH₃)₂, (C₂-C₄alkylOH)₂NHCH₃, (C₆H₅)₄N, (C₆H₅)₃NH, (C₆H₅CH₃)₄N, (C₆H₅CH₃)₃NH, NH₄, melamine, guanidine, an alkali metal or earth alkali metal ion, or an aluminium, zinc, iron or boron ion;
m is a numeral from 1-3 and indicates the number of positive charges on M; and
n is a numeral from 1-3 and indicates the number of phosphinic acid anions corresponding to M^{m+}.

9. A composition according to claim 8, wherein the phosphinic acid salt is of formula (I″)

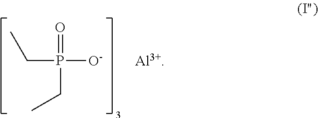

10. A composition according to claim 1, wherein the polymer chain extension agent of Component b) is selected from the group consisting of bisphenol A diglycidyl ethers, ethylene glycidyl methacrylate copolymers, styrene glycidyl methacrylate copolymers and ethylene acrylate glycidyl methacrylate terpolymers.

11. A composition according to claim 1, wherein the polymer chain extension agent of Component b) is a low molecular weight styrene-acrylate epoxy copolymer.

12. A composition according to claim 1, wherein Component c) is an oxide of a metal selected from the group consisting of alkali metals and earth alkaline metals.

13. A composition according to claim 2, wherein Component d) is a salt of metal selected from the group consisting of alkali metals, earth alkaline metals, aluminium, titanium and zinc with a straight chained C₁₄₋₄₀alkyl carboxylic acid.

14. A composition according to claim 13, wherein Component d) is a salt of metal selected from the group consisting of sodium, calcium, barium, aluminium and zinc with stearic acid.

15. A composition according to claim 1, which comprises
a) A phosphinic acid salt of formula (I″), 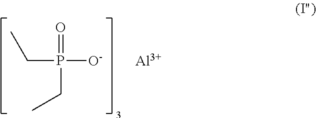
b) A low molecular weight styrene-acrylate epoxy copolymer;
c) At least one oxide of a metal selected from the group consisting of alkali metals and earth alkaline metals; and
d) An alkali metal or earth alkaline metal salt of an organic carboxylic acid; and, optionally,
e) A polymer substrate.

16. A process for imparting flame retardancy to a polymer substrate which process comprises adding to the polymer substrate the composition according to claim 1 with the optional addition of an alkali metal or earth alkaline metal salt of an organic carboxylic acid.
